(19) United States
(12) Patent Application Publication
(10) Pub. No.: US 2002/0097577 A1
(43) Pub. Date: Jul. 25, 2002

(54) Mini firecracker light

(75) Inventor: Peter K. H. Huang, Taipei (TW)

Correspondence Address: DOUGHERTY & TROXELL, SUITE 1404, 5205 LEESBURG PIKE, FALLS CHURCH, VA, 22041, US

(73) Assignee: Shining Blick Enterprises Co., Ltd.

(21) Appl. No.: 09/897,926

(22) Filed: Jul. 5, 2001

(30) Foreign Application Priority Data
Jan. 19, 2001 (TW) 090201149

(51) Int. Cl. F21V 11/00

(52) U.S. Cl. 362/240; 362/249; 362/431; 362/251

(57) ABSTRACT

A mini firecracker light comprising: a hollow transparent pipe of a predetermined length; a plurality of lamp strings arranged partly in the transparent pipe upwardly from below, and partly exposed to the area above the transparent pipe connecting to the lamp strings in the transparent pipe and arranged in circles with different diameters going in the mode of radiation at different levels; all the lamp strings are controlled by an IC controller for turning on/off in a way that the lamp strings are lightened going upwardly from below in a linear mode, then subsequently, the lamp strings outside of the transparent pipe gradually flash in a way of radiating from the lower area to the higher area thereof. When in use, a viewing effect of firecrackers as if the crackers are ignited to explode can be obtained; the firecracker light is suitable especially for using by families or individual persons.

### BACKGROUND OF THE INVENTION

1. Field of the invention

The present invention is related to a mini firecracker light, and especially to a light made from a plurality of lamp strings of low cost and with a viewing effect of firecrackers as if the crackers are ignited to explode, it is suitable especially for using by families or individual persons.

2. Description of the Prior Art

Earlier decorative lamps mostly have a lot of light beads on a single conductor, by electric connection of the conductor, the light beads illuminate or flash to obtain a decoration effect, decoration effect of such conventional lamp strings is still monolithic and not vivid enough though. Decorative lamps used nowadays give the function of creating various illuminating letters or patterns through electronic controlled netting devices; decorative net lights or netting lamps used for this were disclosed in the U.S. Pat. Nos. 5, 645,342 and 5,951,146. However, such decorative lamps normally are larger by size and cost higher.

And among lamp designing in the present days generally, for the purpose of more embodying, injection molding is used to make imitated figures (such as Santa Claus) or imitated articles (such as a meteor). And then the figures or articles are decorated with lamp beads individually, they display the images of Santa Claus or the meteor when are electrically turned on, such as is the case of the U.S. Pat. No. 5,712,770; however, such decorating things are fixed per se, the decoration effect of them is stationary, they are inferior in attraction.

### SUMMARY OF THE INVENTION

The object of the present invention is to provide a mini firecracker light suitable especially for using by families or individual persons and having a viewing effect of firecrackers (such as soaring fireworks) giving a decoration effect as if the crackers are ignited to explode.

To obtain the above stated object, the present invention provides a hollow transparent pipe able to be positioned at a suitable location, a part of plural lamp strings can be arranged in the transparent pipe upwardly from below, the others of the lamp strings are exposed to the area above the transparent pipe; these exposed lamp strings can be distributed radiantly in circles of various diameters above the transparent pipe and respectively at different levels. All the lamp strings can be controlled by an IC controller for turning on/off in a way that the lamp strings can be lightened one by one going upwardly from below, then subsequently, the lamp strings outside of the pipe gradually flash in a way of radiating from the lower area to the higher area thereof.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view of a preferred embodiment of the present invention;

FIG. 2 is an analytical perspective view showing the elements of the embodiment of FIG. 1;

FIG. 3 is a is a sectional view taken from FIG. 1;

FIG. 4 is shows an electric circuit diagram of the preferred embodiment of the present invention;

FIG. 5 is a flow chart showing the process of the preferred embodiment of the present invention.

### DETAILED DESCRIPTION OF THE PREFERRED EMBODIMENT

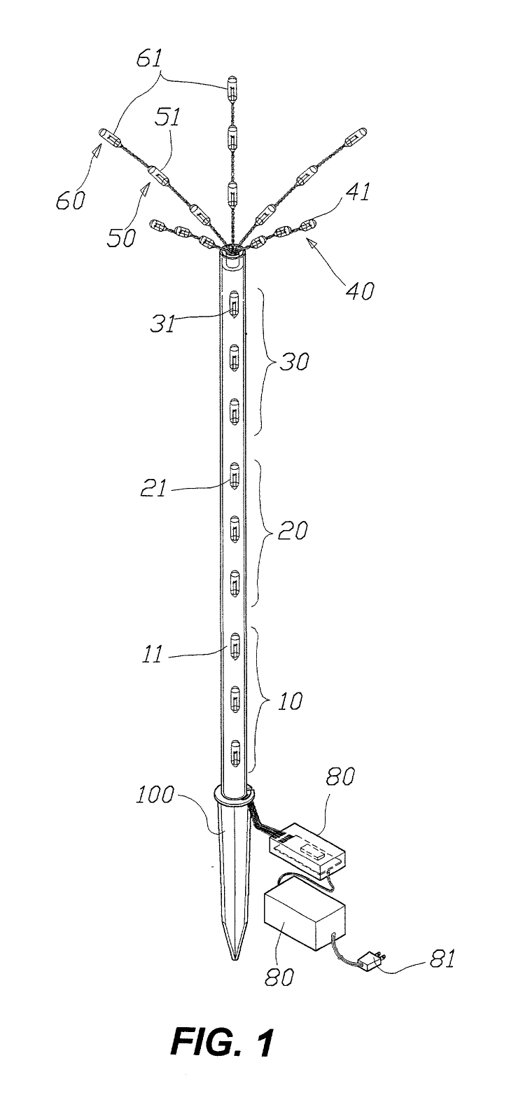

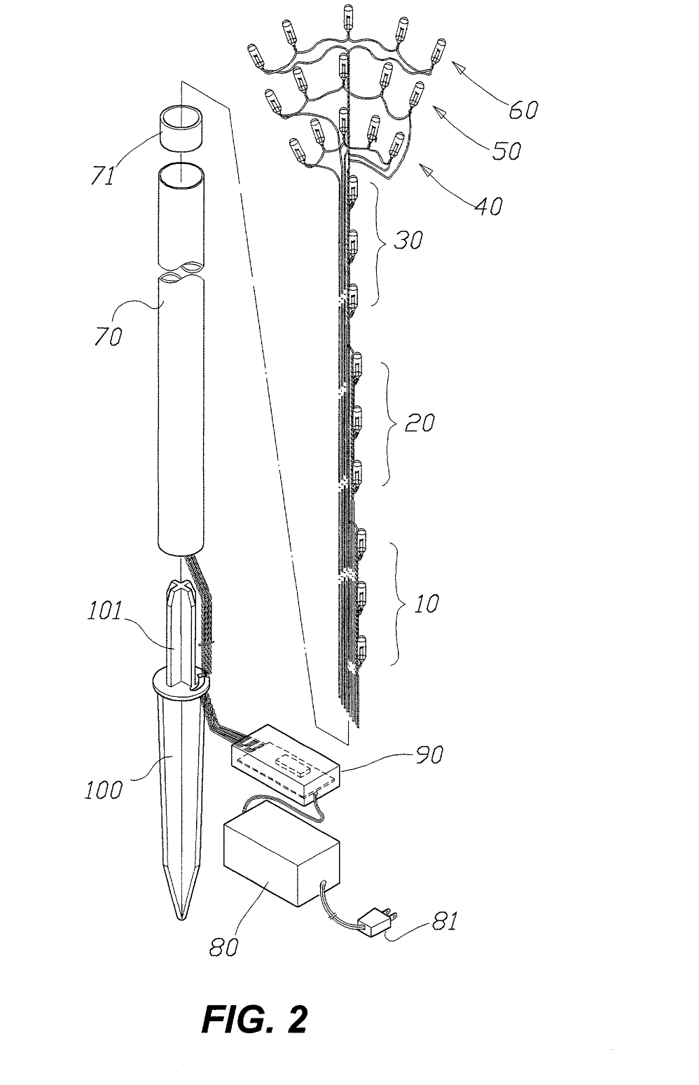

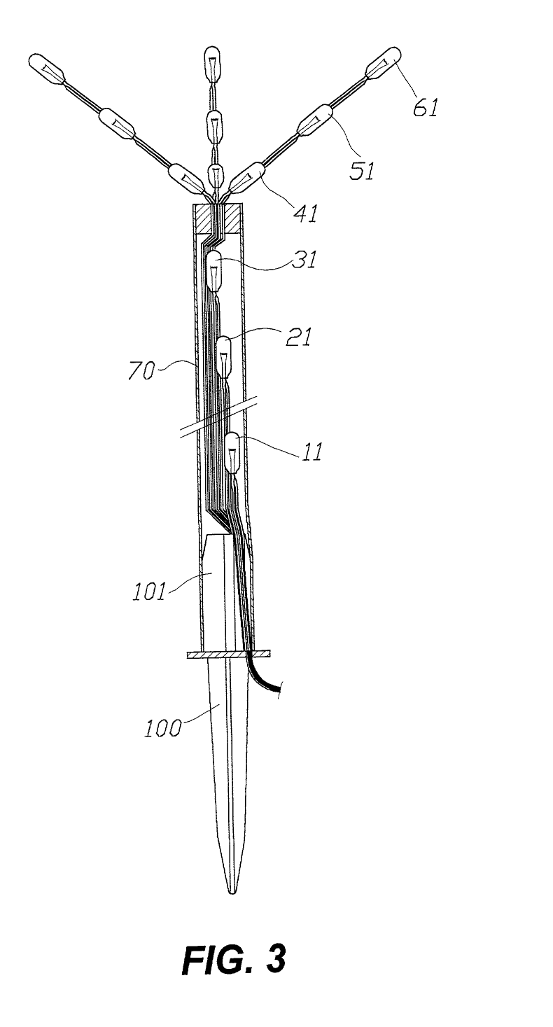

Referring to FIG. 1-3, in this embodiment, the present invention is comprised of six lamp strings 10, 20, 30, 40, 50 and 60, the number of lamp strings is only an example convenient for explanation, and not for limiting the present invention; and is comprised of a transparent pipe 70 which is placed therein part of the lamp strings in order that the others of the lamp strings are exposed to the area above the transparent pipe 70, a rectifier 80, a controller 90 and a bottom positioning member 100.

The transparent pipe 70 can be made of transparent or half-transparent material into a hollow pipe with suitable length, in the embodiment shown, the lamp strings 10, 20 and 30 are sequentially mounted in the transparent pipe 70. In this embodiment, the lamp bulbs 11 of the lamp string 10 are placed in the lower section of the transparent pipe 70, the lamp bulbs 21 of the lamp string 20 are placed in the middle section of the transparent pipe 70 subsequent to the lamp string 10, while the lamp bulbs 31 of the lamp string 30 are placed in the upper section of the transparent pipe 70 subsequent to the lamp string 20.

And subsequent to the lamp string 30 placed in the upper section of the transparent pipe 70, the fourth lamp string 40 has a plurality of lamp bulbs 41 arranged in a circle with a radiation form and with a smaller diameter to be exposed to the area above the transparent pipe 70, in this preferred embodiment, the lamp bulbs 41 of the fourth lamp string 40 are disposed at a lower level. Subsequent to the fourth lamp string 40, the fifth lamp string 50 has a plurality of lamp bulbs 51 arranged in a circle with a radiation form and with a larger diameter above the lamp bulbs 41 of the fourth lamp string 40, and then the sixth lamp string 60 has a plurality of lamp bulbs 61 disposed at the most outside location.

In order to make convenient distribution of the lamp bulbs 41, 51 and 61 of the fourth, fifth and sixth lamp strings 40, 50 and 60, the transparent pipe 70 is provided on the top thereof with a positioning inner sleeve 71. In a more preferred embodiment, the positioning inner sleeve 71 is an elastic and flexible pipe, so that it can position on one hand all the lamp strings 40, 50 and 60 outside of the transparent pipe 70, and on the other hand can randomly adjust the orientations of all the lamp strings 40, 50 and 60 by its elasticity and flexibility. For the purpose of positioning the entire mini firecracker light on the ground or some other location conveniently, the bottom positioning member 100 in the embodiment shown is in the shape of a pike, and is provided with an extended block 101 to be inserted into the bottom hole of the transparent pipe 70. And the conductors of all the lamp strings 40, 50 and 60 are connected to the controller 90 which is connected by means of another conductor to the rectifier 80 and then to a power plug 81.

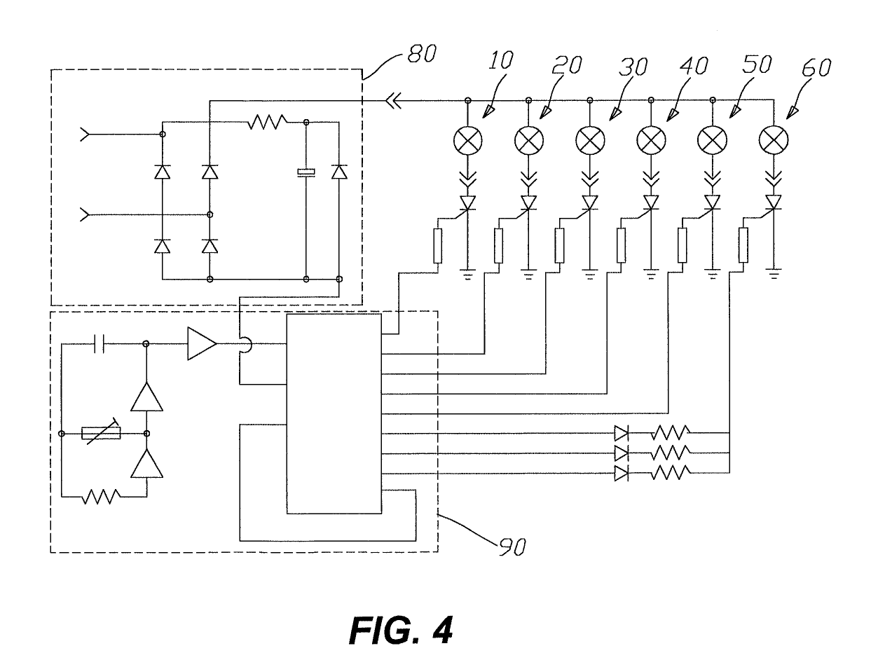

As shown in FIG. 4, all the lamp strings 10, 20, 30, 40, 50 and 60 of the present invention are controlled by an IC to turn on to flash or turn off in sequence. In the practical embodiment of circuit, an input power source is filtered and full-wave rectified through the rectifier 80. The lamp strings 10, 20, 30, 40, 50 and 60 connecting in series are controlled by an IC through a silicon controlled rectifier for individually and sequentially turning on/off. In this preferred embodiment, the sixth lamp string 60 disposed at the most outside location can flash thrice.

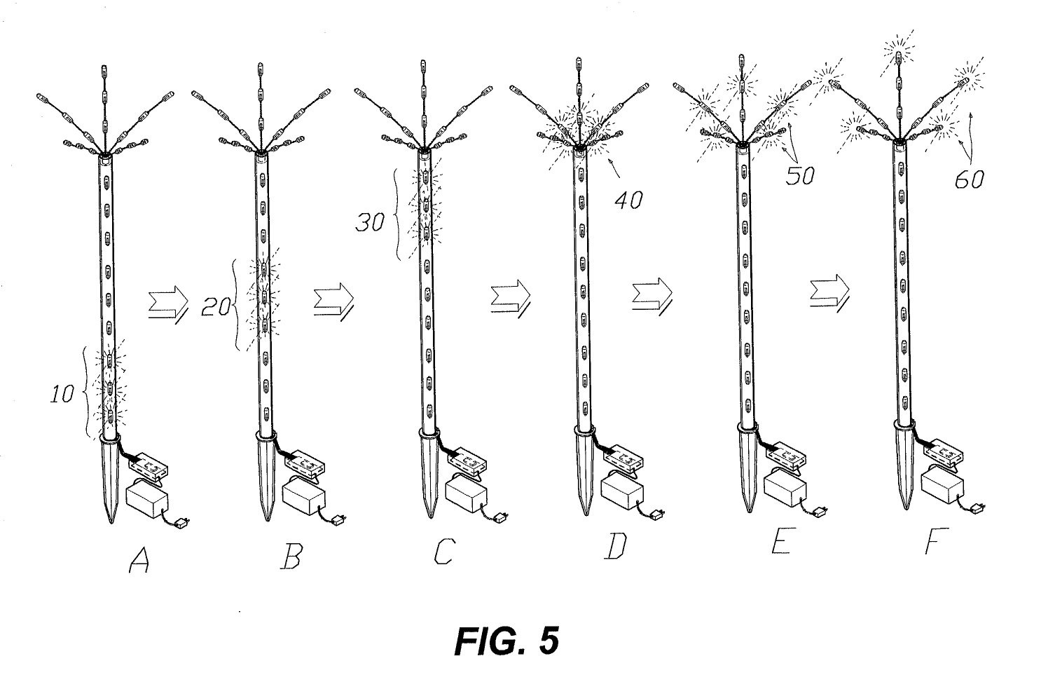

Through the above stated practical circuit control, as shown in FIG. 5, after the present invention is connected to a power supply and the controller 90 is activated, the first lamp string 10 is turned on to flash and then is turned off, the second and the third lamp strings 20, 30 and the fourth and fifth lamp strings 40, 50 outside of the pipe 70 are all turned on/off in the same mode, and lastly, the sixth lamp string 60 flashes continuously thrice, these make a circulation. In such a circulation, the mini firecracker light is gradually lightened going upwardly from below in a linear mode, then going in the mode of radiation outside of the pipe 70 from a lower level through a middle level, and repeatedly flashes at the most outside location, this makes an viewing effect of firecrackers (such as soaring fireworks), and provides a vision effect of novelty, attraction as well as brilliance.

The present invention constructs such a decorative light made from a plurality of lamp strings of low cost and with an viewing effect of firecrackers, it is suitable especially for using by families or individual persons. By its low cost and small volume, it can be more popularized.

The embodiment cited above is only for illustrating a preferred embodiment and not for giving any limitation to the scope of the present invention. It will be apparent to those skilled in this art that various modifications or changes can be made to and shall fall within the scope of the appended claims of the present invention.

1. A mini firecracker light comprising:
a hollow transparent pipe of a predetermined length;
a plurality of lamp strings arranged partly in said transparent pipe upwardly from below to connect at the bottom of said transparent pipe with an power supply and an IC controller, and partly exposed to the area above said transparent pipe connecting to said lamp strings in said transparent pipe and arranged in circles with different diameters going in the mode of radiation at different levels; all said lamp strings are controlled by an IC controller for turning on/off in a way that said lamp strings are lightened one by one going upwardly from below, then subsequently, said lamp strings outside of said transparent pipe gradually flash in a way of radiating from the lower area to the higher area thereof.

2. A mini firecracker light as claimed in claim 1, wherein, said transparent pipe is provided on the top thereof with a positioning inner sleeve to position said lamp strings outside of said transparent pipe, and is provided at the bottom end thereof with a bottom positioning member.

3. A mini firecracker light as claimed in claim 1, wherein, said lamp strings outside of said transparent pipe are arranged with radiation forms respectively in a circle at a lower level and with a smaller diameter, and in circles at higher levels with larger diameters.

4. A mini firecracker light as claimed in claims 1-3, wherein, said lamp string disposed at said most outside location is set to flash multiple times.

5. A mini firecracker light as claimed in claim 2, wherein, said positioning inner sleeve is an elastic and flexible pipe for positioning and adjusting orientations of said lamp strings outside of said transparent pipe.
